(19) United States
(12) Patent Application Publication
(10) Pub. No.: US 2015/0235602 A1
(43) Pub. Date: Aug. 20, 2015

(54) Image Display Method for a Half-Source Driving Liquid Crystal Display

(71) Applicant: AU Optronics Corp., Hsin-Chu (TW)

(72) Inventors: Hang-Chang Tseng, Hsin-Chu (TW); Nan-Ying Lin, Hsin-Chu (TW); Chung-Lung Li, Hsin-Chu (TW); Fu-Yuan Liou, Hsin-Chu (TW); Chung-Lin Fu, Hsin-Chu (TW)

(21) Appl. No.: 14/483,164

(22) Filed: Sep. 11, 2014

(30) Foreign Application Priority Data
Feb. 17, 2014 (TW) 103105133

(51) Int. Cl. G09G 3/36

(52) U.S. Cl. CPC G09G 3/3622; G09G 2340/0457; G09G 2310/027

(57) ABSTRACT

An image display method of a half-source-driving (HSD) liquid crystal display (LCD) for mitigating the screen flickering effect caused by applying a frame rate control (FRC) algorithm in the LCD includes providing a first gate sequence corresponding to a pixel array in the LCD display. If a target gray level of the pixel array is an average value of a first gray level and a second gray level, write the first gray level to a plurality of sub-pixels of the pixel array being charged first according to the first gate sequence, and write the second gray level smaller than the first gray level to a plurality of sub-pixels of the pixel array being charged latter according to the first gate sequence.

### BACKGROUND OF THE INVENTION

1. Field of the Invention

The present invention provides an image display method, and more particularly, image display method for a half-source driving liquid crystal display under various frame rate control algorithms.

2. Description of the Prior Art

A liquid crystal display (LCD) has been widely used and replaced a cathode ray tube (CRT) as the mainstream display device since it has several advantages, such as a minimal linear error, occupying small space, high mobility, little radiation, and power saving. LCDs are used to display images with various resolutions and sizes. They are used as computer monitors, cellphone panels, TV screens, etc. Nowadays, as the demand for higher resolution increases, LCDs with a half-source-driving (LCD-HSD) structure have been developed. The LCD-HSD structure provides LCDs smaller space and lower power consumption thereby increasing the resolution.

Generally, the display panel of LCD includes a plurality of pixel arrays, a plurality of corresponding gate lines, and a plurality of corresponding data lines. Each pixel array includes a plurality of sub-pixels. Each sub-pixel corresponds to a different primary color, where the primary color can be defined by an RGB or CMYK color model. When the sub-pixel is enabled by the corresponding gate line, a corresponding gray level is written to the sub-pixel by the corresponding data line. As known, a different gray level yields different transmittances of the sub-pixel. When the plurality of sub-pixels on the LCD panel is presented various gray levels, the digital image with various colors and light intensities is shown. Generally, since each sub-pixel can present 256 gray levels (i.e., it is assumed that the LCD can display 256 gray levels, where the 256 gray levels are sorted by gray level 0 to gray level 255), a storage device is essential for saving the data of 256 gray levels in the LCD device and thus occupies the circuit space of the LCD. To reduce the circuit space of the storage device, only M gray levels are saved in the LCD device (i.e., M is a positive integer and 1<M<256). The residual 256-M gray levels can be presented by combining M gray levels based on an image display method called a frame rate control (FRC) algorithm.

In the FRC algorithm, the main idea is to use two or more gray levels selecting from M gray levels and then respectively write these selected M gray levels to the different group of the sub-pixels of the pixel array with different quantities. This means that the sub-pixels of the pixel array are divided into two or more sets. The corresponding gray level is written to each set of sub-pixels in order to display a target gray level by the pixel array. Particularly, the target gray level indicates the expected value or average value of gray level of the pixel array. Thus, the FRC algorithm uses two or more sets of sub-pixels with respect to M gray levels for achieving the target gray level.

Consider that the FRC algorithm is applied to an LCD-HSD. Since the sub-pixels of pixel array are charged sequentially, when two adjacent sub-pixels are written to the same gray levels, the sub-pixel being charged first is presented a gray level representing a lower light intensity than the sub-pixel being charged latter. This implies that when a predetermined gray level is written to the sub-pixel being charged first, the sub-pixel being charged first is presented a different gray level from a predetermined gray level, causing flicker and roll line effects on the display and thereby reducing the image display quality.

### SUMMARY OF THE INVENTION

According to an embodiment, the image display method for a half-source driving liquid crystal display is disclosed. The liquid crystal display includes a plurality of pixel arrays, a plurality of corresponding gate lines, and a plurality of corresponding data lines. Each pixel array includes a plurality of sub-pixels. Two adjacent sub-pixels are coupled to the same corresponding data line and are disposed at two different sides of the data line and are also coupled to two consecutive corresponding gate lines. The image display method includes providing a first gate sequence to a pixel array of the LCD. If a target gray level equals an average value of a first gray level and a second gray level, a first gray level is written to a plurality of sub-pixels of the pixel array being charged first according to the first gate sequence, and a second gray level is written to a plurality of sub-pixels of the pixel array being charged latter according to the first gate sequence. The first gray level is greater than the second gray level.

According to an additional embodiment, another image display method for a half-source driving liquid crystal display is disclosed. The liquid crystal display includes a plurality of pixel arrays, a plurality of corresponding gate lines, and a plurality of corresponding data lines. Each pixel array includes a plurality of sub-pixels. Two adjacent sub-pixels are coupled to a same corresponding data line and are disposed at two different sides of the data line and are also coupled to two consecutive corresponding gate lines. The image display method includes providing a first gate sequence to the pixel array of the LCD. If a target gray level is closer to a second gray level than a first gray level, the first gray level is written to a first set of sub-pixels of the pixel array being charged first according to the first gate sequence, the second gray level is written to a second set of sub-pixels of the pixel array being charged first according to the first gate sequence, and the second gray level is written to a plurality of sub-pixels of the pixel array being charged latter according to the first gate sequence. The first gray level is greater than the second gray level.

According to an additional embodiment, another image display method for a half-source driving liquid crystal display is disclosed. The liquid crystal display includes a plurality of pixel arrays, a plurality of corresponding gate lines, and a plurality of corresponding data lines. Each pixel array includes a plurality of sub-pixels. Two adjacent sub-pixels are coupled to a same corresponding data line and are disposed at two different sides of the data line and are also coupled to two consecutive corresponding gate lines. The image display method includes providing a first gate sequence to the pixel array of LCD. If a target gray level is closer to a first gray level than a second gray level, the first gray level is written into a plurality of sub-pixels of the pixel array being charged first according to the first gate sequence, the second gray level is written into a first set of sub-pixels of the pixel array being charged latter according to the first gate sequence, and the first gray level is written into a second set of sub-pixels of the pixel array being charged latter according to the first gate sequence. The first gray level is greater than the second gray level.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is the structure of a half-source-driving LCD according to an embodiment of the present invention.

FIG. 2 is the pixel array corresponding to the structure of the half-source-driving LCD illustrated in FIG. 1.

### DETAILED DESCRIPTION

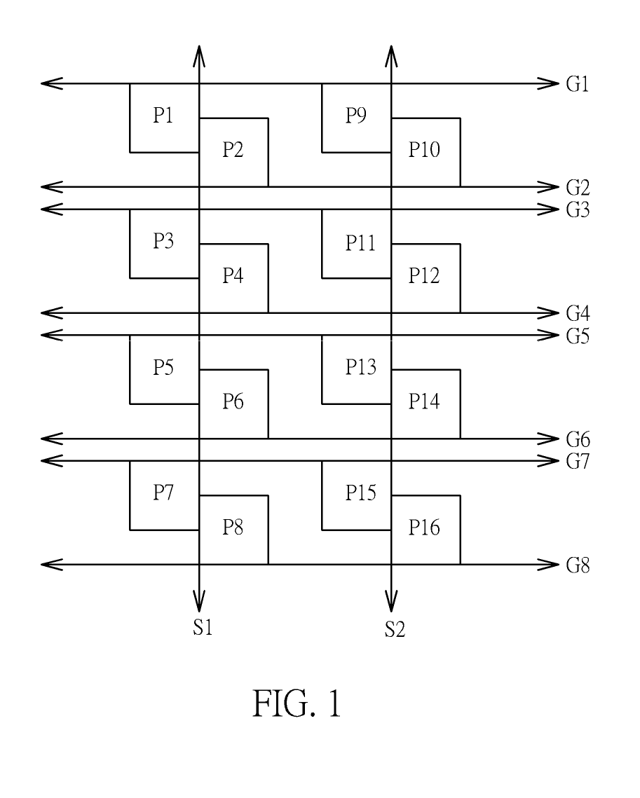

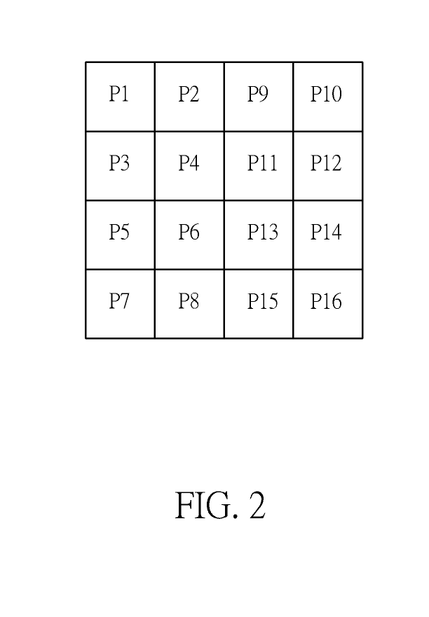

Please refer to FIG. 1 and FIG. 2. FIG. 1 is the structure of a half-source-driving LCD according to an embodiment of the present invention. FIG. 2 is the pixel array corresponding to the structure of the half-source-driving illustrated in FIG. 1. In FIG. 1, 16 sub-pixels are in the embodiment are considered as sub-pixel P1 to sub-pixel P16. These sub-pixels are controlled by data line S1, data line S2, and gate lines G1 to G8. Two adjacent sub-pixels coupled to the data line S1 at different sides are respectively coupled to two consecutive gate lines. This means that the sub-pixels P1 and P2 are respectively coupled to the gate lines G1 and G2. The sub-pixels P3 and P4 are respectively coupled to the gate lines G3 and G4. The sub-pixels P5 and P6 are respectively coupled to the gate lines G5 and G6. The sub-pixels P7 and P8 are respectively coupled to the gate lines G7 and G8. Similarly, two adjacent sub-pixels coupled to the data line S2 at different sides are respectively coupled to two consecutive gate lines. This means that the sub-pixels P9 and P10 are respectively coupled to the gate lines G1 and G2. The sub-pixels P11 and P12 are respectively coupled to the gate lines G3 and G4. The sub-pixels P13 and P14 are respectively coupled to the gate lines G5 and G6. The sub-pixels P15 and P16 are respectively coupled to the gate lines G7 and G8. The sub-pixel P1 to sub-pixel P16 are charged and enabled progressively according to a predetermined gate sequence. In this embodiment, the predetermined gate sequence is assumed to be 21345687. The sub-pixels coupled to the data line S1 are enabled by the order of gate sequence, as sub-pixels P2, sub-pixels P1, sub-pixels P3, sub-pixels P4, sub-pixels P5, sub-pixels P6, sub-pixels P8, and sub-pixels P7. The sub-pixels coupled to the data line S2 are enabled by the order of gate sequence, as sub-pixels P10, sub-pixels P9, sub-pixels P11, sub-pixels P12, sub-pixels P13, sub-pixels P14, sub-pixels P16, and sub-pixels P15. For presentation convenience, the sub-pixels being charged first denote that the sub-pixels are charged first according to the gate sequence. The sub-pixels being charged latter denote that the sub-pixels are charged latter according to the gate sequence. In this embodiment, the sub-pixels being charged first include sub-pixels P2, sub-pixels P3, sub-pixels P5, sub-pixels P8, sub-pixels P10, sub-pixels P11, sub-pixels P13, and sub-pixels P16. The sub-pixels being charged latter include sub-pixels P1, sub-pixels P4, sub-pixels P6, sub-pixels P7, sub-pixels P9, sub-pixels P12, sub-pixels P14, and sub-pixels P15. Note that the pixel array according to the embodiment of the present invention is considered as a 4 by 4 matrix. As shown in FIG. 2, the pixel array includes 16 sub-pixels as sub-pixel P1 to sub-pixel P16. The order for enabling the sub-pixels of the pixel array according to the gate sequence is identical to the order for enabling the sub-pixels of half-source-driving structure in FIG. 1.

The first embodiment for the image display method of half-source-driving liquid crystal display of the present invention is illustrated in the following. Here, three frame rate control (FRC) algorithms are considered to present the target gray level of the pixel array, named as FRC(01) algorithm, FRC(10) algorithm, and FRC(11) algorithm. Specifically, 4 sub-pixels carrying the first gray level and 12 sub-pixels carrying the second gray level of the pixel array are applied in FRC(01) algorithm to present the target gray level of the pixel array. 8 sub-pixels carrying the first gray level and 8 sub-pixels carrying the second gray level of the pixel array are applied in the FRC(10) algorithm to present the target gray level of the pixel array. 12 sub-pixels carrying the first gray level and 4 sub-pixels carrying the second gray level of the pixel array are applied in the FRC(11) algorithm to display the target gray level of the pixel array. In this embodiment, the first gray level is greater than the second gray level. The gate sequence of this embodiment is considered as 21345687. The detail expressions of the image display method are illustrated below.

When the display uses the FRC(01) algorithm to present the target gray level of the pixel array, the sub-pixels of the pixel array being charged first are sub-pixel P2, sub-pixel P3, sub-pixel P5, sub-pixel P8, sub-pixel P10, sub-pixel P11, sub-pixel P13, and sub-pixel P16. The sub-pixels of the pixel array being charged latter are sub-pixel P1, sub-pixel P4, sub-pixel P6, sub-pixel P7, sub-pixel P9, sub-pixel P12, sub-pixel P14, and sub-pixel P15. The light intensity of the sub-pixels being charged first is lower than the light intensity of sub-pixels being charged latter. As known, reducing the contrast of the displayed gray level of the pixel array can mitigate the image flicker and roll line effect. By doing so, the plurality of sub-pixels being charged first is divided into two sets. These two sets of sub-pixels being charged first have the same quantities and can be formed by several combinations. For example, the first set of the sub-pixels being charged first can be located on the pixel array in sparse distribution or in dense distribution. When the first set of the sub-pixels being charged first is located on the pixel array in sparse distribution, the pixel array can be presented to a uniform contrast of gray level while resulting in satisfactory image display quality. In this case, the first set of the sub-pixels being charged first includes sub-pixel P2, sub-pixel P3, sub-pixel P13, and sub-pixel P16. The second set of the sub-pixels being charged first includes sub-pixel P5, sub-pixel P8, sub-pixel P10, and sub-pixel P11. The first gray level is written to the first set of the sub-pixels being charged first. The second gray level is written to the second set of the sub-pixels being charged first and all the sub-pixels being charged latter. The first set of the sub-pixels being charged first is presented a smaller gray level than the first gray level. The second set of the sub-pixels being charged first is presented a smaller gray level than the second gray level. This means that sub-pixel P2, sub-pixel P3, sub-pixel P13, and sub-pixel P16 are presented a smaller gray level than the first gray level. Sub-pixel P1, sub-pixel P4, sub-pixel P6, sub-pixel P7, sub-pixel P9, sub-pixel P12, sub-pixel P14, and sub-pixel P15 are presented the gray level equal to the first gray level. Sub-pixel P5, sub-pixel P8, sub-pixel P10, and sub-pixel P11 are presented a smaller gray level than the second gray level.

When the display uses the FRC(10) algorithm to present the target gray level of the pixel array, since the gate sequence is identical to the case of the FRC(01) algorithm in this embodiment, the plurality of sub-pixels being charged first and the plurality of sub-pixels being charged latter are identical to the case of FRC(01) in this embodiment. The light intensity of the plurality of sub-pixels being charged first is lower than the light intensity of the plurality of sub-pixels being charged latter. As known, reducing the contrast of the presented gray level of the pixel array can mitigate the image flicker and roll line effect. By doing so, the first gray level is written to 8 sub-pixels being charged first and the second gray level is written to 8 sub-pixels being charged latter. The sub-pixels being charged first are presented to smaller gray level than the first gray level. This means that sub-pixel P2, sub-pixel P3, sub-pixel P5, sub-pixel P8, sub-pixel P10, sub-pixel P11, sub-pixel P13, and sub-pixel P16 are presented to a smaller gray level than the first gray level. Sub-pixel P1, sub-pixel P4, sub-pixel P6, sub-pixel P7, sub-pixel P9, sub-pixel P12, sub-pixel P14, and sub-pixel P15 are presented to the gray level equal to the second gray level.

When the display uses the FRC(11) algorithm to present the target gray level of the pixel array, since the gate sequence in this embodiment is identical to the case of FRC(01) algorithm in this embodiment, the plurality of sub-pixels of the pixel array being charged first and the plurality of sub-pixels of the pixel array being charged latter are identical to the case of FRC(01) algorithm in this embodiment, wherein the sub-pixels being charged first suffer from the effect of low light intensity. To mitigate the image flicker and roll line effect by reducing the contrast of the presented gray level of the pixel array, the plurality of sub-pixels being charged latter are divided into two sets. These two sets of sub-pixels being charged latter have the same quantities and can be formed by several combinations. For example, the first set of the sub-pixels being charged latter can be located on the pixel array in sparse distribution or in dense distribution. When the first set of the sub-pixels being charged latter is located on the pixel array in sparse distribution, the pixel array can be presented to a uniform contrast of gray level while resulting in satisfactory image display quality. In this case, the first set of the sub-pixels being charged latter includes sub-pixel P6, sub-pixel P7, sub-pixel P9, and sub-pixel P12. The second set of the sub-pixels being charged latter includes sub-pixel P1, sub-pixel P4, sub-pixel P14, and sub-pixel P15. The second gray level is written to the first set of the sub-pixels being charged latter. The first gray level is written to the second set of the sub-pixels being charged latter and all the sub-pixels being charged first. The plurality of sub-pixels being charged first is presented to smaller gray level than the first gray level. This means that sub-pixel P2, sub-pixel P3, sub-pixel P5, sub-pixel P8, sub-pixel P10, sub-pixel P11, sub-pixel P13, and sub-pixel P16 are presented to smaller gray level than the first gray level. Sub-pixel P1, sub-pixel P4, sub-pixel P14, and sub-pixel P15 are presented to the gray level equal to the first gray level. Sub-pixel P6, sub-pixel P7, sub-pixel P9, and sub-pixel P12 are presented to the gray level equal to the second gray level.

The second embodiment for the image display method of the half-source driving liquid crystal display of the present invention is illustrated in the following. Different from the first embodiment by enabling the sub-pixels according to a single gate sequence and writing the corresponding gray level into each sub-pixel, the image display method in the second embodiment can avoid the lifetime reduction problem in the first embodiment. As known, when the same gray level is repeatedly written to the same sub-pixel, the lifetime of the sub-pixel is reduced. For example, in the first embodiment, the first gray level is repeatedly written to sub-pixel P2 and thus reduces the lifetime of sub-pixel P2. In the second embodiment, two different gate sequences are alternatively used during the timing interval of consecutive four image frames. Here, four image frames are indicated as the first image frame, the second image frame, the third image frame, and the fourth image frame. Two different gate sequences are indicated as the first gate sequence and the second gate sequence. In this embodiment, the first gate sequence is defined as 21345687. The second sequence is defined as 12436578. Consider that the FRC(01), FRC(10), and FRC(11) algorithms are used to present the target gray level of the pixel array. In the second embodiment, the first set of the sub-pixels being charged first, the second set of the sub-pixels being charged first, the first set of the sub-pixels being charged latter, and the second set of the sub-pixels being charged latter according to the first gate sequence and the second gate sequence can be formed by several combinations. For presentation convenience, a specific combination is used in the second embodiments to present the target gray level of the pixel array, as follows.

When the display uses the FRC(01) algorithm to present the target gray level of the pixel array, in the first image frame, the method of the first gray level and the second gray level written to the plurality of sub-pixels of the pixel array according to the first gate sequence is identical to the case of the FRC(01) algorithm in the first embodiment. In the third image frame, the method of the first gray level and the second gray level written to the plurality of sub-pixels of the pixel array according to the first gate sequence is similar to the case of the first image frame in this embodiment. The difference is that the first set and the second set of the sub-pixels being charged first are different from the case of the first image frame in this embodiment. In the third image frame, the first set of the sub-pixels being charged first includes sub-pixel P5, sub-pixel P8, sub-pixel P10, and sub-pixel P11. The second set of the sub-pixels being charged first includes sub-pixel P2, sub-pixel P3, sub-pixel P13, and sub-pixel P16. In the second and the fourth image frames, since the odd-ordered elements of the second gate sequence are identical to the even-ordered elements of the first gate sequence and the even-ordered elements of the second gate sequence are identical to the odd-ordered elements of the first gate sequence, the sub-pixels being charged first of the pixel array in the first and the third image frames are respectively identical to the sub-pixels being charged latter in the second and the fourth image frames. In the second and the fourth image frames, the method of the first gray level and the second gray level written to the plurality of sub-pixels according to the second gate sequence is to write the first gray level to the first set of the sub-pixels being charged first and write the second gray level to the second set of the sub-pixels being charged first and all the sub-pixels being charged latter. The first set and the second set of the sub-pixels being charged first in the second image frame and the fourth image frame are different. In the second image frame, the first set of the sub-pixels being charged first includes sub-pixel P1, sub-pixel P6, sub-pixel P12, and sub-pixel P15. The second set of the sub-pixels being charged first includes sub-pixel P4, sub-pixel P7, sub-pixel P8, and sub-pixel P13. In the fourth image frame, the first set of the sub-pixels being charged first includes sub-pixel P4, sub-pixel P7, sub-pixel P8, and sub-pixel P13. The second set of the sub-pixels being charged first includes sub-pixel P1, sub-pixel P6, sub-pixel P12, and sub-pixel P15. According to the image display method in this embodiment, during the timing interval of consecutive four image frames, the first gray level is written to each sub-pixel during the timing interval of one image frame. The second gray level is written to each sub-pixel during the timing interval of three image frames.

When the display uses the FRC(10) algorithm to present the target gray level of the pixel array, in the first and the third image frames, the method of the first gray level and the second gray level written to the plurality of sub-pixels of the pixel array according to the first gate sequence is identical to the case of the FRC(10) algorithm in the first embodiment. In the second and the fourth image frames, since the odd-ordered elements of the second gate sequence are identical to the even-ordered elements of the first gate sequence and the even-ordered elements of the second gate sequence are identical to the odd-ordered elements of the first gate sequence, the sub-pixels being charged first in the first and the third image frames are respectively identical to the sub-pixels being charged latter in the second and the fourth image frames. The sub-pixels being charged latter of the pixel array in the first and the third image frames are respectively identical to the sub-pixels being charged first in the second and the fourth image frames. In the second and the fourth image frames, the method of the first gray level and the second gray level written to the plurality of sub-pixels according to the second gate sequence is to write the first gray level to the sub-pixels being charged first and write the second gray level to the sub-pixels being charged latter. According to the image display method in this embodiment, during the timing interval of consecutive four image frames, the first gray level is written to each sub-pixel during the timing interval of two image frames. The second gray level is written to each sub-pixel during the timing interval of two image frames.

When the display uses the FRC(11) algorithm to present the target gray level of the pixel array, in the third image frame, the method of the first gray level and the second gray level written to the plurality of sub-pixels of the pixel array according to the first gate sequence is identical to the case of FRC(11) in the first embodiment. In the first image frame, the method of the first gray level and the second gray level written to the plurality of sub-pixels of the pixel array according to the first gate sequence is similar to the case of the third image frame in this embodiment. The difference is that the first set and the second set of the sub-pixels being charged latter are different from the case of the third image frame in this embodiment. In the first image frame, the first set of the sub-pixels being charged latter includes sub-pixel P1, sub-pixel P4, sub-pixel P14, and sub-pixel P15. The second set of the sub-pixels being charged latter includes sub-pixel P6, sub-pixel P7, sub-pixel P9, and sub-pixel P12. In the second and the fourth image frames, since the odd-ordered elements of the second gate sequence are identical to the even-ordered elements of the first gate sequence and the even-ordered elements of the second gate sequence are identical to the odd-ordered elements of the first gate sequence, the sub-pixels being charged first in the first and the third image frames are respectively identical to the sub-pixels being charged latter in the second and the fourth image frames. The sub-pixels being charged latter in the first and the third image frames are respectively identical to the sub-pixels being charged first in the second and the fourth image frames. In the second and the fourth image frames, the method of the first gray level and the second gray level written to the plurality of sub-pixels according to the second gate sequence is to write the second gray level to the first set of the sub-pixels being charged latter and write the first gray level to the second set of the sub-pixels being charged latter and all the sub-pixels being charged first. The first set and the second set of the sub-pixels being charged latter in the second image frame and the fourth image frame are different. In the second image frame, the first set of the sub-pixels being charged latter includes sub-pixel P3, sub-pixel P8, sub-pixel P10, and sub-pixel P13. The second set of the sub-pixels being charged latter includes sub-pixel P2, sub-pixel P5, sub-pixel P11, and sub-pixel P16. In the fourth image frame, the first set of the sub-pixels being charged latter includes sub-pixel P2, sub-pixel P5, sub-pixel P11, and sub-pixel P16. The second set of the sub-pixels being charged latter includes sub-pixel P3, sub-pixel P8, sub-pixel P10, and sub-pixel P13. According to the image display method in this embodiment, during the timing interval of consecutive four image frames, the first gray level is written to each sub-pixel during the timing interval of three image frames. The second gray level is written to each sub-pixel during the timing interval of one image frame.

The third embodiment for the image display method of the half-source driving liquid crystal display of the present invention is illustrated in the following. Different from the aforementioned second embodiment, four different gate sequences are alternatively used during the timing interval of consecutive four image frames in this embodiment. Four different gate sequences are indicated as the first gate sequence, the second gate sequence, the third gate sequence, and the fourth gate sequence. In this embodiment, the first gate sequence is defined as 21345687. The second sequence is defined as 12436578. The third gate sequence is defined as 21435687. The fourth gate sequence is defined as 12346578. Consider that FRC(01), FRC(10), and FRC(11) algorithms are used to present the target gray level of the pixel array. In the third embodiment, the first set of the sub-pixels being charged first, the second set of the sub-pixels being charged first, the first set of the sub-pixels being charged latter, and the second set of the sub-pixels being charged latter according to the first gate sequence and the second gate sequence can be formed by several combinations. For presentation convenience, a specific combination is used in the third embodiment to present the target gray level of the pixel array, as follows.

When the display uses the FRC(01) algorithm to present the target gray level of the pixel array, in the first and the second image frames, the method of the first gray level and the second gray level written to the plurality of sub-pixels of the pixel array according to the first gate sequence(in the first image frame) and the second gate sequence(in the second image frame) is identical to the case of the FRC(01) algorithm in the first and the second image frames of the second embodiment. Specifically, the methods of the first gray level and the second gray level written to the plurality of sub-pixels in the third and the fourth image frames are similar. The common idea is to write the first gray level to the first set of the sub-pixels being charged first and write the second gray level to the second set of the sub-pixels being charged first and all the sub-pixels being charged latter. However, since the gate sequences corresponding to the third and the fourth image frames are different, the plurality of sub-pixels being charged first and the plurality of sub-pixels being charged latter are different. In the third image frame, according to the third gate sequence, the sub-pixels being charged first include sub-pixel P2, sub-pixel P4, sub-pixel P15, sub-pixel P8, sub-pixel P10, sub-pixel P12, sub-pixel P13, and sub-pixel P16. The residual sub-pixels of the pixel array are the sub-pixels being charged latter. These sub-pixels being charged first are further divided into the first set of the sub-pixels being charged first and the second set of the sub-pixels being charged first. In the third image frame, the first set of the sub-pixels being charged first includes sub-pixel P4, sub-pixel P5, sub-pixel P8, and sub-pixel P10. The second set of the sub-pixels being charged first includes sub-pixel P2, sub-pixel P12, sub-pixel P13, and sub-pixel P16. In the fourth image frame, since the odd-ordered elements of the fourth gate sequence are identical to the even-ordered elements of the third gate sequence and the even-ordered elements of the fourth gate sequence are identical to the odd-ordered elements of the third gate sequence, the sub-pixels being charged first of the pixel array in the third image frame are identical to the sub-pixels being charged latter of the pixel array in the fourth image frame. The sub-pixels being charged latter of the pixel array in the third image frame are identical to the sub-pixels being charged first of the pixel array in the fourth image frame. Further, in the fourth image frame, the first set of the sub-pixels being charged first includes sub-pixel P7, sub-pixel P8, sub-pixel P10, and sub-pixel P13. The second set of the sub-pixels being charged first includes sub-pixel P1, sub-pixel P3, sub-pixel P6, and sub-pixel P14. According to the image display method in this embodiment, during the timing interval of consecutive four image frames, the first gray level is written to each sub-pixel during the timing interval of one image frame. The second gray level is written to each sub-pixel during the timing interval of three image frames.

When the display uses the FRC(10) algorithm to present the target gray level of the pixel array, in the third and the fourth image frames, the first gray level is written to the sub-pixels being charged first and the second gray level is written to the sub-pixels being charged latter. Specifically, since the gate sequences corresponding to the third and the fourth image frames are different, the plurality of sub-pixels being charged first and the plurality of sub-pixels being charged latter are different. In the third image frame, according to the third gate sequence, the sub-pixels of the pixel array being charged first and the sub-pixels of the pixel array being charged latter are identical to the case of the FRC(01) algorithm in the third image frame of this embodiment. In the fourth image frame, according to the fourth gate sequence, the sub-pixels of the pixel array being charged first and the sub-pixels of the pixel array being charged latter are identical to the case of the FRC(01) algorithm in the fourth image frame of this embodiment. According to the image display method in this embodiment, during the timing interval of consecutive four image frames, the first gray level is written to each sub-pixel during the timing interval of two image frames. The second gray level is written to each sub-pixel during the timing interval of two image frames.

When the display uses the FRC(11) algorithm to present the target gray level of the pixel array, in the first and the second image frames, the method of the first gray level and the second gray level written to the plurality of sub-pixels of the pixel array according to the first gate sequence(in the first image frame) and the second gate sequence (in the second image frame) is identical to the case of the FRC(11) algorithm in the first and the second image frames of the second embodiment. Specifically, the methods of the first gray level and the second gray level written to the plurality of sub-pixels in the third and the fourth image frames are similar. The common idea is to write the second gray level to the first set of the sub-pixels being charged latter and write the first gray level to the second set of the sub-pixels being charged latter and all the sub-pixels being charged first. However, since the gate sequences corresponding to the third and the fourth image frames are different, the plurality of sub-pixels being charged first and the plurality of sub-pixels being charged latter are different. In the third image frame, according to the third gate sequence, the sub-pixels of the pixel array being charged first and the sub-pixels of the pixel array being charged latter are identical to the case of the FRC(01) algorithm in the third image frame of this embodiment. In the fourth image frame, according to the fourth gate sequence, the sub-pixels of the pixel array being charged first and the sub-pixels of the pixel array being charged latter are identical to the case of the FRC(01) algorithm in the fourth image frame of this embodiment. In the third image frame, the first set of the sub-pixels being charged latter includes sub-pixel P6, sub-pixel P7, sub-pixel P9, and sub-pixel P11. The second set of the sub-pixels being charged latter includes sub-pixel P1, sub-pixel P3, sub-pixel P14, and sub-pixel P15. In the fourth image frame, the first set of the sub-pixels being charged latter includes sub-pixel P2, sub-pixel P5, sub-pixel P12, and sub-pixel P16. The second set of the sub-pixels being charged latter includes sub-pixel P4, sub-pixel P8, sub-pixel P10, and sub-pixel P13. According to the image display method in this embodiment, during the timing interval of consecutive four image frames, the first gray level is written to each sub-pixel during the timing interval of three image frames. The second gray level is written to each sub-pixel during the timing interval of one image frame.

In the present invention, an image display method of half-source driving liquid crystal display is proposed. The main idea is to use the property that the sub-pixels of the pixel array being charged first are presented to lower light intensity than the sub-pixels of the pixel array being charged latter. It is assumed that the first gray level is greater than the second gray level. When the display uses various frame rate control (FRC) algorithms to present the target gray level of the pixel array, the sub-pixels assigned to the first gray level are located on the sub-pixels being charged first to present the light intensity smaller than the first gray level. The sub-pixels assigned to the second gray level are located on the sub-pixels being charged latter to present the light intensity equal to the second gray level. By doing so, the contrast of the presented gray level of the pixel array for various FRC algorithms can be reduced to mitigate the flicker and roll line effect on the display.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image display method for a half-source-driving liquid crystal display, the liquid crystal display comprising a plurality of pixel arrays, a plurality of gate lines, and a plurality of data lines, each pixel array comprising a plurality of sub-pixels, two adjacent sub-pixels coupled to a data line and disposed at two different sides of the data line being coupled to two consecutive gate lines, the image display method comprising:
providing a first gate sequence to a pixel array of the liquid crystal display; and
if a target gray level of the pixel array equals to an average value of a first gray level and a second gray level, writing the first gray level to a plurality of sub-pixels of the pixel array being charged first according to the first gate sequence and writing the second gray level to a plurality of sub-pixels of the pixel array being charged latter according to the first gate sequence;
wherein the first gray level is greater than the second gray level.

2. The method of claim 1, wherein the pixel array is a 4N×4N matrix, where N is a positive integer.

3. The method of claim 1, wherein a group of sub-pixels of the plurality of sub-pixels coupled to two odd-ordered gate lines and two even-ordered gate lines of eight consecutive gate lines are enabled based on four odd-ordered elements of the first gate sequence, and another group of sub-pixels of the plurality of sub-pixels coupled to another two odd-ordered gate lines and another two even-ordered gate lines of the eight consecutive gate lines are enabled based on four even-ordered elements of the first gate sequence.

4. The method of claim 1, further comprising:
providing a second gate sequence to the pixel array of the liquid crystal display, wherein even-ordered elements of the first gate sequence are identical to odd-ordered elements of the second gate sequence, and odd-ordered elements of the first gate sequence are identical to even-ordered elements of the second gate sequence.

5. An image display method for a half-source-driving liquid crystal display, the liquid crystal display comprising a plurality of pixel arrays, a plurality of gate lines, and a plurality of data lines, each pixel array comprising a plurality of sub-pixels, two adjacent sub-pixels coupled to the a data line and disposed at two different sides of the data line being coupled to two consecutive gate lines, the image display method comprising:
providing a first gate sequence to a pixel array of the liquid crystal display; and
if a target gray level of the pixel array is closer to a second gray level than a first gray level, writing the first gray level to a first set of sub-pixels of the pixel array being charged first according to the first gate sequence, writing the second gray level to a second set of sub-pixels of the pixel array being charged first according to the first gate sequence, and writing the second gray level to a plurality of sub-pixels of the pixel array being charged latter according to the first gate sequence;
wherein the first gray level is greater than the second gray level.

6. The method of claim 5, wherein sub-pixels of the first set of sub-pixels are not adjacent to one another.

7. The method of claim 5, wherein the first set of sub-pixels and the second set of sub-pixels have a same number of sub-pixels.

8. The method of claim 5, wherein the pixel array is a 4N×4N matrix, where N is a positive integer.

9. The method of claim 5, wherein a group of sub-pixels of the plurality of sub-pixels coupled to two odd-ordered gate lines and two even-ordered gate lines of eight consecutive gate lines are enabled based on four odd-ordered elements of the first gate sequence, and another group of sub-pixels of the plurality of sub-pixels coupled to another two odd-ordered gate lines and another two even-ordered gate lines of the eight consecutive gate lines are enabled based on four even-ordered elements of the first gate sequence.

10. The method of claim 5, further comprising:
providing a second gate sequence to the pixel array of the liquid crystal display, wherein even-ordered elements of the first gate sequence are identical to odd-ordered elements of the second gate sequence, and odd-ordered elements of the first gate sequence are identical to even-ordered elements of the second gate sequence.

11. The method of claim 5, wherein during four consecutive image frames, each sub-pixel of the pixel array is displayed with the first gray level in three image frames and displayed with the second gray level in one image frame.

12. An image display method for a half-source-driving liquid crystal display, the liquid crystal display comprising a plurality of pixel arrays, a plurality of gate lines, and a plurality of data lines, each pixel array comprising a plurality of sub-pixels, two adjacent sub-pixels coupled to a data line and disposed at two different sides of the data line being coupled to two consecutive gate lines, the image display method comprising:
providing a first gate sequence to a pixel array of the liquid crystal display; and
if a target gray level of the pixel array is closer to a first gray level than a second gray level, writing the first gray level to a plurality of sub-pixels of the pixel array being charged first according to the first gate sequence, writing the second gray level to a first set of sub-pixels of the pixel array being charged latter according to the first gate sequence, and writing the first gray level to a second set of sub-pixels of the pixel array being charged latter according to the first gate sequence;
wherein the first gray level is greater than the second gray level.

13. The method of claim 12, wherein sub-pixels of the first set of sub-pixels are not adjacent to one another.

14. The method of claim 12, wherein the first set of sub-pixels and the second set of sub-pixels have a same number of sub-pixels.

15. The method of claim 12, wherein the pixel array is a 4N×4N matrix, where N is a positive integer.

16. The method of claim 12, wherein a group of sub-pixels of the plurality of sub-pixels coupled to two odd-ordered gate lines and two even-ordered gate lines of eight consecutive gate lines are enabled based on four odd-ordered elements of the first gate sequence, and another group of sub-pixels of the plurality of sub-pixels coupled to another two odd-ordered gate lines and another two even-ordered gate lines of the eight consecutive gate lines are enabled based on four even-ordered elements of the first gate sequence.

17. The method of claim 12, further comprising:
providing a second gate sequence to the pixel array of the liquid crystal display, wherein even-ordered elements of the first gate sequence are identical to odd-ordered elements of the second gate sequence, and odd-ordered elements of the first gate sequence are identical to even-ordered elements of the second gate sequence.

18. The method of claim 12, wherein during four consecutive image frames each sub-pixel of the pixel array is displayed with the first gray level in one image frame and displayed with the second gray level in three image frames.
